(19) United States
(12) Patent Application Publication
(10) Pub. No.: US 2026/0135998 A1
(43) Pub. Date: May 14, 2026

(54) Inter-Prediction In Region-Adaptive Hierarchical Transform Coding

(71) Applicants: Douyin Vision Co., Ltd., Beijing (CN); Bytedance Inc., Los Angeles, CA (US)

(72) Inventors: Bharath VISHWANATH, San Diego, CA (US); Yingzhan XU, Beijing (CN); Kai ZHANG, San Diego, CA (US); Li ZHANG, San Diego, CA (US)

(21) Appl. No.: 19/443,440

(22) Filed: Jan. 8, 2026

Related U.S. Application Data
(63) Continuation of application No. PCT/CN2024/104463, filed on Jul. 9, 2024.

(30) Foreign Application Priority Data
Jul. 10, 2023 (WO) PCT/CN2023/106495

(51) Int. Cl. H04N 19/109; H04N 19/169; H04N 19/597

(52) U.S. Cl. CPC H04N 19/109; H04N 19/169; H04N 19/597

(57) ABSTRACT

A mechanism for processing video data is disclosed. In an example, the mechanism includes determining to disable alternating current (AC) inter-prediction based on a direct current (DC) of a reference node, a DC of a current node, and one or more thresholds when a Region-Adaptive Hierarchical Transform (RAHT) in Geometry-based Point Cloud Compression (G-PCC) is utilized. A conversion can then be performed between a visual media data and a bitstream with the AC inter-prediction disabled.

### CROSS-REFERENCE TO RELATED APPLICATIONS

This is a continuation of International Patent Application No. PCT/CN2024/104463 filed on Jul. 9, 2024, which claims the priority to and the benefits of International Patent Application No. PCT/CN2023/106495 filed on Jul. 10, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing media data, comprising determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized; and performing a conversion between a visual media data and a bitstream with the AC inter-prediction disabled.

Optionally, in any of the preceding aspects, another implementation of the aspect provides disabling the AC inter-prediction when the following condition is satisfied:

$$D {C}_{c u r} \leq T {h}_{1} * D {C}_{ref} or D {C}_{c u r} \geq T {h}_{2} * D {C}_{ref}$$

where Th1 is a first threshold from the one or more thresholds, and Th2 is a second threshold from the one or more thresholds.

Optionally, in any of the preceding aspects, another implementation of the aspect provides that the DC_{ref} is in a RAHT transform domain when the AC inter-prediction is performed in a transform domain.

Optionally, in any of the preceding aspects, another implementation of the aspect provides replacing the condition based on an attributes value of a parent of a current node and an attributes value of a parent of a reference node.

Optionally, in any of the preceding aspects, another implementation of the aspect provides replacing the DC_{cur} with a sum of the attributes value of the parent of the current node, and replacing the DC_{ref} with a sum of the attributes value of the parent of the reference node.

Optionally, in any of the preceding aspects, another implementation of the aspect provides replacing the DC_{cur} with an average of the attributes value of the parent of the current node, and replacing the DC_{ref} with an average of the attributes value of the parent of the reference node.

Optionally, in any of the preceding aspects, another implementation of the aspect provides that the DC_{ref} is derived from one or more nodes in a reference point cloud (PC) sample.

Optionally, in any of the preceding aspects, another implementation of the aspect provides that the sum of the attributes value of the parent of the reference node is derived from one or more nodes in a reference point cloud (PC) sample.

Optionally, in any of the preceding aspects, another implementation of the aspect provides the average of the attributes value of the parent of the reference node is derived from one or more nodes in a reference point cloud (PC) sample.

Optionally, in any of the preceding aspects, another implementation of the aspect provides that the DC_{ref} is derived from a corresponding node in a reference point cloud (PC) sample.

Optionally, in any of the preceding aspects, another implementation of the aspect provides that the DC_{ref} is derived from a corresponding node after motion compensation.

Optionally, in any of the preceding aspects, another implementation of the aspect provides that the DC_{ref} is derived by interpolating at a position in a reference point cloud (PC) sample.

Optionally, in any of the preceding aspects, another implementation of the aspect provides that the first threshold (Th₁) and the second threshold (Th₂) are fixed at an encoder and at a decoder.

Optionally, in any of the preceding aspects, another implementation of the aspect provides that the first threshold (Th₁) and the second threshold (Th₂) are transmitted to a decoder.

Optionally, in any of the preceding aspects, another implementation of the aspect provides that the one or more thresholds are different for at least one of different sequences and different frames.

Optionally, in any of the preceding aspects, another implementation of the aspect provides that the one or more thresholds are different for different attribute channels.

Optionally, in any of the preceding aspects, another implementation of the aspect provides that the one or more thresholds are different for at least one of different regions and different RAHT layers.

Optionally, in any of the preceding aspects, another implementation of the aspect provides that the one or more thresholds are dependent on one or more factors comprising quantization parameter and global motion.

Optionally, in any of the preceding aspects, another implementation of the aspect provides disabling the AC inter-prediction when the following condition is satisfied:

$$D {C}_{c u r} < T {h}_{1} * D {C}_{ref} or D {C}_{c u r} > T {h}_{2} * D {C}_{r e f}$$

where Th1 is a first threshold from the one or more thresholds, and Th2 is a second threshold from the one or more thresholds.

Optionally, in any of the preceding aspects, another implementation of the aspect provides using an interpolation technique in a reference frame for the AC inter-prediction when a reference node is not present at a motion compensation location.

Optionally, in any of the preceding aspects, another implementation of the aspect provides that the interpolation technique comprises nearest-neighbor interpolation.

Optionally, in any of the preceding aspects, another implementation of the aspect provides that the nearest-neighbor interpolation is based on a Euclidean distance.

Optionally, in any of the preceding aspects, another implementation of the aspect provides that the nearest-neighbor interpolation is based on a closest Morton code.

Optionally, in any of the preceding aspects, another implementation of the aspect provides that the interpolation technique depends on the DC_{cur}.

Optionally, in any of the preceding aspects, another implementation of the aspect provides performing a search in a reference point cloud (PC) sample to determine a node with a DC closest to the DC_{cur}.

Optionally, in any of the preceding aspects, another implementation of the aspect provides that jointly determining a best reference node based on both a spatial distance and a difference between the DC_{cur} and DC_{ref}, wherein the spatial difference comprises a Euclidean distance or a Morton code distance.

Optionally, in any of the preceding aspects, another implementation of the aspect provides that the interpolation technique comprises interpolation at a reference node, and wherein the interpolation at the reference node is based on a plurality of neighbors.

Optionally, in any of the preceding aspects, another implementation of the aspect provides that each of the plurality of neighbors is weighted based on its distance to a point of interpolation.

Optionally, in any of the preceding aspects, another implementation of the aspect provides that a number of the plurality of neighbors is fixed.

Optionally, in any of the preceding aspects, another implementation of the aspect provides that a number of the plurality of neighbors is based on at least one of a RAHT layer and an attribute channel.

Optionally, in any of the preceding aspects, another implementation of the aspect provides that one or more of a maximum number of the plurality of neighbors and a minimum number of the plurality of neighbors is transmitted to a decoder.

Optionally, in any of the preceding aspects, another implementation of the aspect provides determining that one or more of the plurality of neighbors are ineligible for the interpolation technique based on an eligibility criterion, and disabling use of the one or more of the plurality of neighbors that were determined to be ineligible.

Optionally, in any of the preceding aspects, another implementation of the aspect provides using an interpolation result to generate an inter-prediction value.

Optionally, in any of the preceding aspects, another implementation of the aspect provides deriving the AC inter-prediction based on the interpolation technique, and then combining the AC inter-prediction with intra-prediction to obtain a final prediction.

Optionally, in any of the preceding aspects, another implementation of the aspect provides that the final prediction comprises an average of the AC inter-prediction and the intra-prediction.

Optionally, in any of the preceding aspects, another implementation of the aspect provides that the final prediction comprises a weighted average of the AC inter-prediction and the intra-prediction, and wherein weights are predetermined for different layers or transmitted to a decoder.

Optionally, in any of the preceding aspects, another implementation of the aspect provides determining a spatio-temporal prediction based on spatial neighbors in a current point cloud (PC) sample and neighbors in a reference PC sample.

Optionally, in any of the preceding aspects, another implementation of the aspect provides that weights for interpolation are based on factors including at least one of temporal distance and spatial distance.

Optionally, in any of the preceding aspects, another implementation of the aspect provides that weights for interpolation are fixed or transmitted to a decoder.

Optionally, in any of the preceding aspects, another implementation of the aspect provides that whether to and/or how to apply any of the disclosed methods is signaled from an encoder to a decoder in at least one of a bitstream, a frame, a tile, a slice, or an octree.

Optionally, in any of the preceding aspects, another implementation of the aspect provides that whether to and/or how to apply any of the disclosed methods is based on coded information including one or more of a dimension, a color format, a color component, a slice type, and a picture type.

Optionally, in any of the preceding aspects, another implementation of the aspect provides that the conversion includes encoding the media data into a bitstream.

Optionally, in any of the preceding aspects, another implementation of the aspect provides that the conversion includes decoding the media data from a bitstream.

A second aspect relates to an apparatus for processing video data comprising: a processor; and a non-transitory memory with instructions thereon, wherein the instructions upon execution by the processor, cause the processor to perform any of the disclosed methods.

A third aspect relates to a non-transitory computer readable medium comprising a computer program product for use by a video coding device, the computer program product comprising computer executable instructions stored on the non-transitory computer readable medium such that when executed by a processor cause the video coding device to perform any of the disclosed methods.

A fourth aspect relates to a non-transitory computer-readable recording medium storing a bitstream of a video which is generated by a method performed by a video processing apparatus, wherein the method comprises: determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized; and generating the bitstream with the AC inter-prediction disabled.

A fifth aspect relates to a method for storing bitstream of a video comprising: determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized; generating the bitstream with the AC inter-prediction disabled; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an example of parent-level nodes for each sub-node of transform unit node.

FIG. 2 is a block diagram showing an example video processing system.

FIG. 3 is a block diagram of an example video processing apparatus.

FIG. 4 is a flowchart for an example method of video processing.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. Initial Discussion

This disclosure is related to media file format. Specifically, it is related to point cloud attribute inter prediction in region-adaptive hierarchical transform. The ideas may be applied individually or in various combination, to any point cloud coding standard or non-standard point cloud codec, e.g., the being-developed Geometry based Point Cloud Compression (G-PCC).

### 2. Abbreviations

G-PCC—Geometry based Point Cloud Compression
MPEG—Moving Picture Experts Group
3DG—3D Graphics Coding Group
CFP—Call For Proposal
V-PCC—Video-based Point Cloud Compression
RAHT—Region-Adaptive Hierarchical Transform

### 3. Further Discussion

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard[1]. The final standard will consist in two classes of solutions. V ideo-based Point Cloud Compression (V-PCC) is appropriate for point sets with a relatively uniform distribution of points[2]. Geometry-based Point Cloud Compression (G-PCC) is appropriate for more sparse distributions[3]. Both V-PCC and G-PCC support the coding and decoding for single point cloud and point cloud sequence.

In one-point cloud, there may be geometry information and attribute information. Geometry information is used to describe the geometry locations of the data points. Attribute information is used to record some details of the data points, such as textures, normal vectors, reflections and so on.

### 3.1 Region-Adaptive Hierarchical Transform

In G-PCC, one of the point cloud attribute coding tools is RAHT. RAHT is a transform that uses the attributes associated with a node in a lower level of the octree to predict the attributes of the nodes in the next level[4]. RAHT assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension (e.g., along z, then y, then x). If there are L levels in the octree, RAHT takes 3 L levels to traverse the tree backwards.

Let the nodes at level l be g_{l,x,y,z}, for x, y, z integers. g_{l,x,y,z} was obtained by grouping g_{l+1,2x,y,z} and g_{1+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,yz} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+l,y,z}, with their respective weights, ω_{l,2x,y,z} and ω_{l,2x+1,y,z}, RAHT apply the following transform:

$$[ \begin{matrix}{ℊ}_{l - 1 , x , y , z} \\ {h}_{l - 1 , x , y , z}\end{matrix} ] = {T}_{{ω}_{1} {ω}_{2}} [ \begin{matrix}{ℊ}_{l , 2 x , y , z} \\ {h}_{l , 2 x + 1 , y , z}\end{matrix} ] , where {ω}_{1} = {ω}_{l , 2 x , y , z} and {ω}_{2} = {ω}_{l , 2 x + 1 , y , z} and {T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ \sqrt{- {ω}_{2}} & {\sqrt{ω}}_{1}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example:

$${ω}_{l - 1 , 2 , y , z} = {ω}_{l , 2 x , y , z} + {ω}_{l , 2 x + 1 , y , z}$$

In the last stage, the tree root, the remaining two voxels g_{l,0,0,0} and g_{l,1,0,0} are transformed into the final two coefficients as:

$$\begin{matrix}[ \begin{matrix}{ℊ}_{D C} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{ℊ}_{1 , 0 , 0 , 0} \\ {ℊ}_{1 , 1 , 0 , 0}\end{matrix} ] \\ Where {ℊ}_{D C} = {ℊ}_{0 , 0 , 0 , 0} .\end{matrix}$$

### 3.2 Upsampled Transform Domain Prediction in RAHT

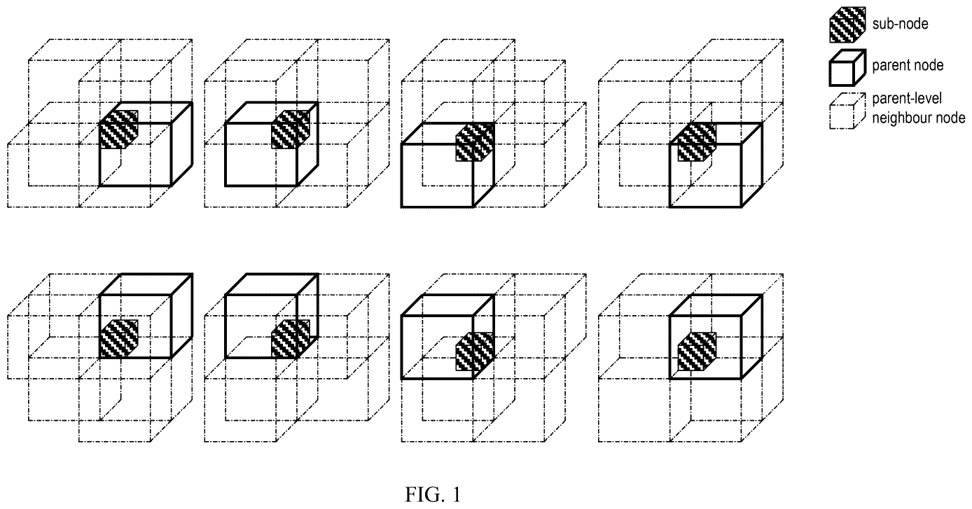

FIG. 1 is an example of parent-level nodes for each sub-node of transform unit node.

The transform domain prediction is introduced to improve coding efficiency on RAHT[5]. RAHT is formed of two parts.

Firstly, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Secondly, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side.

Each sub-node of transform unit node is predicted by 7 parent-level nodes where 3 coline parent-level neighbour nodes, 3 coplane parent-level neighbour nodes and 1 parent node. Coplane and coline neighbours are the neighbours that share a face and an edge with current transform unit node, respectively. FIG. 1 illustrates 7 parent-level nodes for each sub-node of transform unit node.

The attribute aᵤₚ of each sub-node is predicted depending on the distance between it and its parent-level node as follows:

$${a}_{u p} = \sum {ω}_{k} {a}_{k} / \sum {ω}_{k}$$

where aₖ is the attribute of its one parent-level node and ωₖ is weight depending on the distance. In G-PCC, ωₚₐᵣₑₙₜ:ω_{coplane}:ω_{coline}=4:2:1.

For AC coefficient, the prediction residual will be signalled.

For DC coefficient, the coefficients are inherited from the previous level, which means that the DC coefficient is signalled without prediction.

### 3.3 Attribute Inter Prediction in RAHT

The attribute inter prediction in RAHT is discussed in [6]. It is proposed to apply inter-prediction to DC and AC coefficients in RAHT. The same octree decomposition is performed on the current frame and the reference frame.

For the first 5 layers, the same scan of the octree is performed on the two frames. Before performing the octree scan backwards, a point-to-point matching process is performed to ensure that the node of the reference frame can establish a corresponding one-to-one relationship with the node of the current frame. Each point in the reference frame will be matched to one point in the current frame in an “upper matching” method. The Morton value of the matched point is the smallest Morton value greater than the Morton value of the current point.

For DC coefficients, the residual between the DC coefficient for the root node of the current frame and the DC coefficient for the root node of the reference frame is calculated as:

$$D {C}_{residual} = D {C}_{c u r r e n t} - D {c}_{reference}$$

The DC_{residual} is signaled to the decoder in place of DC_{current}.

For each node in the first N layers, the average attribute of the node in the same octree location in the reference frame is calculated as Attr_{predicted_inter} and the corresponding AC coefficients are calculated as AC_{predicted_inter}.

For AC coefficients, the prediction residual is signalled as:

$$A {C}_{r e s i d u a l} = A {C}_{c u r r e n t} - A {C}_{p r e d i c t e d} \\ A {C}_{p r e d i c t e d} = A {C}_{pre dicted\_inter} ? A {C}_{pre dicted\_inter} : A {C}_{pre dicted\_intra}$$

If the AC_{predicted_inter} is equal to zero, the AC_{predicted_intra} is applied as the original transform domain prediction.

Another method in GPCC is used to perform prediction in RAHT domain instead of sum of attributes space. Accordingly, in GPCC there are two types: type 0 performs inter-prediction in RAHT domain and type 1 performs prediction in sum of attributes space.

### 4. Technical Problems Solved by Disclosed Technical Solutions

An example design for point cloud attribute inter-prediction in region-adaptive hierarchical transform (RAHT) has the following problems.

First, in an example design, during AC prediction, both encoder and decoder have access to the DC of the current RAHT node and the reference node. However, this information is not utilized in an example design for GPCC.

Second, in the example design, inter-prediction for a RAHT node is applied if and only if a RAHT node is present in the same location in the reference frame. This can be a strict condition and thus needs to be modified.

### 5. A Listing of Solutions and Embodiments

To solve the above problems and some other problems not mentioned, methods as summarized below are disclosed. The items should be considered as examples to explain the general concepts and should not be interpreted in a narrow way. Furthermore, these solutions can be applied individually or combined in any manner.

In the following description, the point cloud (PC) sample may refer to frame/sub-frame/picture/sub-picture/slice/sub-slice/tile and so on.
1) As regards to problem 1, it is proposed to disable the AC inter-prediction based on the DC of reference node (DC_{ref}), the DC of the current node (DC_{cur}) and some thresholds.
   a. In one example, the AC inter-prediction may be disabled when the following condition is satisfied:

$$D {C}_{c u r} \leq T {h}_{1} * D {C}_{ref} or D {C}_{c u r} \geq T {h}_{2} * D {C}_{ref}$$

b. In one example, DC_{ref} may be in RAHT transform domain when inter-prediction is done in transform domain.
c. Alternatively, the condition may be replaced based on the attributes value of the parent of the current node and the attributes of the parent of the reference node.
   i. In one example, DC_{cur} may be replaced by the sum of attributes value of the parent of the current node and DC_{ref} may be replaced by the sum of attributes value of the parent of the reference node.
   ii. Alternatively, DC_{cur} may be replaced by the average of attributes value of the parent of the current node and DC_{ref} may be replaced by the average of attributes value of the parent of the reference node.
d. In one example, DC_{ref} (or equivalently the sum/average of attributes of the parent of the reference) may be derived from node/s in the reference PC sample as:
   i. In one example, DC_{ref} may be derived from corresponding node in the reference PC sample.
   ii. In one example, DC_{ref} may be derived from corresponding node after motion compensation.
   iii. In one example, DC_{ref} may be derived by interpolating at a position in the reference PC sample.
e. In one example, the thresholds Th₁ and Th₂ may be fixed at encoder and decoder.
f In one example, the thresholds Th₁ and Th₂ may be sent to the decoder.
g. In one example, the thresholds may be different for different scenarios:
   i. For example, the threshold could be different for different sequences, frames etc.
   ii. For example, the threshold could be different for different attribute channels.
   iii. For example, the threshold could be different for different regions, RAHT layers etc.
   iv. For example, the threshold could depend on other factors such as QP, global motion etc.
h. In one example, the condition may be replaced by less than (<), instead of less than or equal to (≤). Similar rationale holds good for greater than.
2) As regards to problem 2, it is proposed to relax the constraint and use interpolation techniques in the reference frame for AC inter-prediction when reference node is not present at the motion compensated location.
   a. In one example, the interpolation technique could be the nearest-neighbor interpolation.
      i. In one example, the nearest neighbor could be based on Euclidean distance.
      ii. In one example, the nearest neighbor could be based on the closest Morton code.
   b. In one example, the interpolation may depend on the DC of the current node.
      i. For example, a search may be performed in the reference PC sample to determine a node whose DC is closest to the current DC.
      ii. For example, both spatial distance (such as Euclidean or Morton code difference) and the difference between DC of the current node and reference node may be jointly used to determine the best reference node.
   c. In one example, the interpolation at the reference node could be based on multiple neighbors.
      i. In one example, the neighbors may be weighted based on their distance to the point of interpolation.
      ii. In one example, the number of such neighbors for interpolation may be fixed.
      iii. In one example, the number of such neighbors may be different and may depend on factors such as RAHT layer, attribute channel etc.
      iv. In one example, the maximum number or the minimum number of neighbors may be sent to the decoder.
   d. In one example, the interpolation may be jointly applied with the eligibility criterion previously disclosed to disable the usage of the neighbors that are ineligible according to the proposed criterion.
   e. In one example, the interpolation result may be used to generate the inter prediction value.
   f. In one example, after deriving the inter-prediction based on interpolation, it may be further combined with the intra-prediction to obtain the final prediction.
      i. For example, the final prediction could be the average of both predictions.
      ii. For example, the final prediction may be a weighted average and weights may be pre-determined for different layers or could be explicitly sent to the decoder.
   g. In one example, spatial neighbors in the current PC sample and the neighbors in the reference PC sample may be jointly considered for a joint spatio-temporal prediction.
      i. The weights for interpolation may depend on factors such as temporal distance, spatial distance etc.
      ii. The weights may be fixed or may be explicitly sent to the decoder.
3) Whether to and/or how to apply a method disclosed above may be signaled from encoder to decoder in a bitstream/frame/tile/slice/octree/etc.
4) Whether to and/or how to apply the disclosed methods above may be dependent on coded information, such as dimensions, colour format, colour component, slice/picture type.

### 6. References

[1] MPEG 3DG and Requirements, “Call for Proposals for Point Cloud Compression V2”, ISO/IEC JTC1/SC29 WG11 N16763.
[2] ISO/IEC JTC 1/SC 29/WG 07, “Information technology—Coded Representation of Immersive Media—Part 5: Visual Volumetric Video-based Coding (V3C) and Video-based Point Cloud Compression (V-PCC)”, ISO/IEC 23090-5.
[3] ISO/IEC JTC 1/SC 29/WG 11, “Information technology—MPEG-I (Coded Representation of Immersive Media)—Part 9: Geometry-based Point Cloud Compression”, ISO/IEC 23090-9:2020(E).
[4] Ricardo L. De Queiroz and Philip A. Chou, “Compression of 3D Point Clouds Using a Region-Adaptive Hierarchical Transform”, IEEE Transactions on Image Processing.
[5]S. Lasserre, D. Flynn, “On an improvement of RAHT to exploit attribute correlation”, ISO/IEC JTC1/SC29/WG11 M47378.
[6]Y.-Z. Xu, W. Wang, K. Zhang, L. Zhang, [G-PCC][EE13.2 related][New proposal] Inter-Prediction for RAHT Attribute Coding, ISO/IEC JTC1/SC29/WG7 m61083, October 2022.

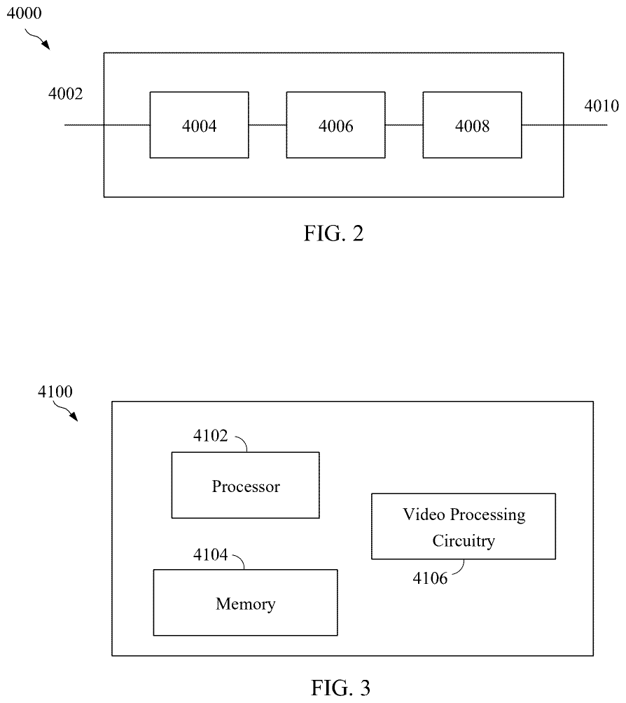

FIG. 2 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

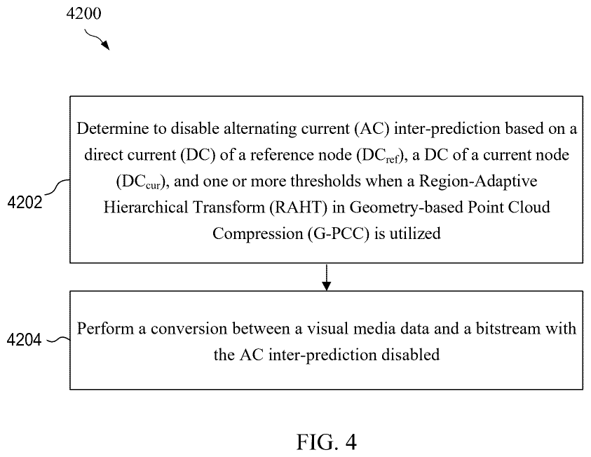

FIG. 4 is a flowchart for an example method 4200 of video processing. In block 4202, the method 4200 includes determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized. In block 4204, a conversion is performed between a visual media data and a bitstream with the AC inter-prediction disabled. The conversion of step 4204 may include encoding at an encoder or decoding at a decoder, depending on the example.

In an embodiment, the method 4200 includes disabling the AC inter-prediction when the following condition is satisfied:

$$D {C}_{c u r} \leq T {h}_{1} * D {C}_{ref} or D {C}_{c u r} \geq T {h}_{2} * D {C}_{ref}$$

where Th1 is a first threshold from the one or more thresholds, and Th2 is a second threshold from the one or more thresholds.

In an embodiment, the DC_{ref} is in a RAHT transform domain when the AC inter-prediction is performed in a transform domain. In an embodiment, the method 4200 includes replacing the condition based on an attributes value of a parent of a current node and an attributes value of a parent of a reference node.

In an embodiment, the method 4200 includes replacing the DC_{cur} with a sum of the attributes value of the parent of the current node, and replacing the DC_{ref} with a sum of the attributes value of the parent of the reference node. In an embodiment, the method 4200 includes replacing the DC_{cur} with an average of the attributes value of the parent of the current node, and replacing the DC_{ref} with an average of the attributes value of the parent of the reference node.

In an embodiment, the DC_{ref} is derived from one or more nodes in a reference point cloud (PC) sample. In an embodiment, the sum of the attributes value of the parent of the reference node is derived from one or more nodes in a reference point cloud (PC) sample. In an embodiment, the average of the attributes value of the parent of the reference node is derived from one or more nodes in a reference point cloud (PC) sample. In an embodiment, the DC_{ref} is derived from a corresponding node in a reference point cloud (PC) sample.

In an embodiment, the DC_{ref} is derived from a corresponding node after motion compensation. In an embodiment, the DC_{ref} is derived by interpolating at a position in a reference point cloud (PC) sample. In an embodiment, the first threshold (Th₁) and the second threshold (Th₂) are fixed at an encoder and at a decoder. In an embodiment, the first threshold (Th₁) and the second threshold (Th₂) are transmitted to a decoder. In an embodiment, the one or more thresholds are different for at least one of different sequences and different frames. In an embodiment, the one or more thresholds are different for different attribute channels.

In an embodiment, the one or more thresholds are different for at least one of different regions and different RAHT layers. In an embodiment, the one or more thresholds are dependent on one or more factors comprising quantization parameter and global motion.

In an embodiment, the method 4200 includes disabling the AC inter-prediction when the following condition is satisfied:

$$D {C}_{c u r} < T {h}_{1} * D {C}_{ref} or D {C}_{c u r} > T {h}_{2} * D {C}_{r e f}$$

where Th1 is a first threshold from the one or more thresholds, and Th2 is a second threshold from the one or more thresholds.

In an embodiment, the method 4200 includes using an interpolation technique in a reference frame for the AC inter-prediction when a reference node is not present at a motion compensation location.

In an embodiment, the interpolation technique comprises nearest-neighbor interpolation. In an embodiment, the nearest-neighbor interpolation is based on a Euclidean distance. In an embodiment, the nearest-neighbor interpolation is based on a closest Morton code. In an embodiment, the interpolation technique depends on the DC_{cur}. In an embodiment, the method 4200 includes performing a search in a reference point cloud (PC) sample to determine anode with a DC closest to the DC_{cur}. In an embodiment, jointly determining a best reference node based on both a spatial distance and a difference between the DC_{cur} and DC_{ref}, wherein the spatial difference comprises a Euclidean distance or a Morton code distance.

In an embodiment, the interpolation technique comprises interpolation at a reference node, and wherein the interpolation at the reference node is based on a plurality of neighbors. In an embodiment, each of the plurality of neighbors is weighted based on its distance to a point of interpolation. In an embodiment, a number of the plurality of neighbors is fixed. In an embodiment, a number of the plurality of neighbors is based on at least one of a RAHT layer and an attribute channel. In an embodiment, one or more of a maximum number of the plurality of neighbors and a minimum number of the plurality of neighbors is transmitted to a decoder.

In an embodiment, the method 4200 includes determining that one or more of the plurality of neighbors are ineligible for the interpolation technique based on an eligibility criterion, and disabling use of the one or more of the plurality of neighbors that were determined to be ineligible. In an embodiment, the method 4200 includes using an interpolation result to generate an inter-prediction value. In an embodiment, the method 4200 includes deriving the AC inter-prediction based on the interpolation technique, and then combining the AC inter-prediction with intra-prediction to obtain a final prediction. In an embodiment, the final prediction comprises an average of the AC inter-prediction and the intra-prediction.

In an embodiment, the final prediction comprises a weighted average of the AC inter-prediction and the intra-prediction, and wherein weights are predetermined for different layers or transmitted to a decoder. In an embodiment, the method 4200 includes determining a spatio-temporal prediction based on spatial neighbors in a current point cloud (PC) sample and neighbors in a reference PC sample. In an embodiment, weights for interpolation are based on factors including at least one of temporal distance and spatial distance. In an embodiment, weights for interpolation are fixed or transmitted to a decoder.

In an embodiment, whether to and/or how to apply any of the disclosed methods is signaled from an encoder to a decoder in at least one of a bitstream, a frame, a tile, a slice, or an octree.

In an embodiment, whether to and/or how to apply any of the disclosed methods is based on coded information including one or more of a dimension, a color format, a color component, a slice type, and a picture type.

The method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

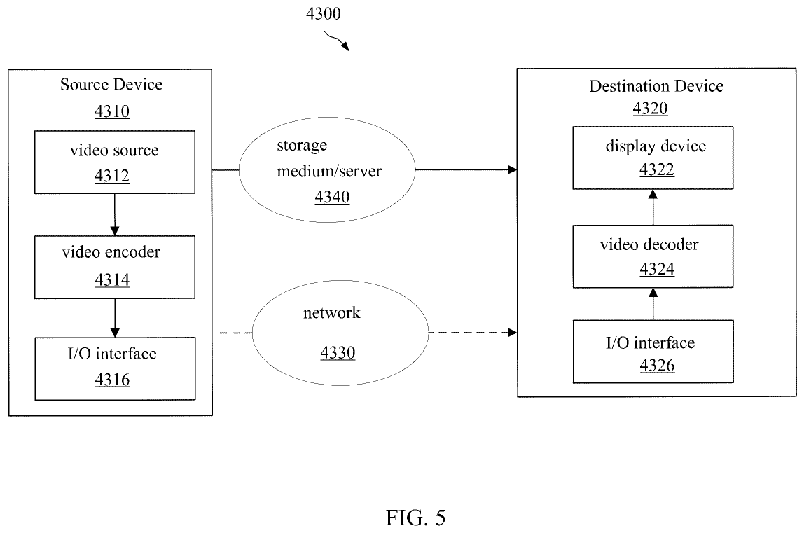

FIG. 5 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

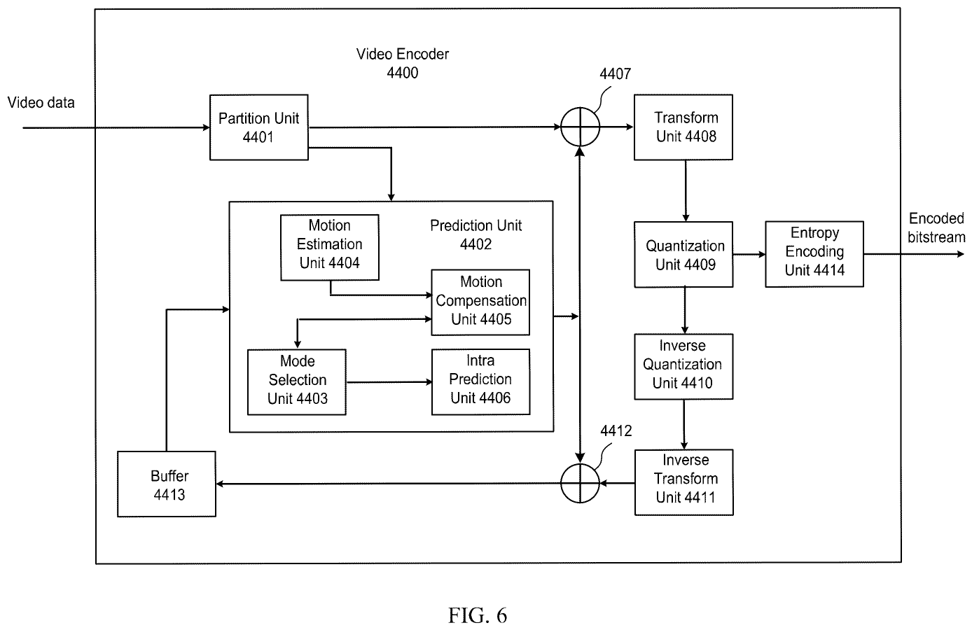

FIG. 6 is a block diagram illustrating an example of video encoder 4400, which may be video encoder 4314 in the system 4300 illustrated in FIG. 5. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform unit 4408 may generate one or more transform coefficient video blocks for the current video block by applying one or more transforms to a residual video block associated with the current video block.

After transform unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

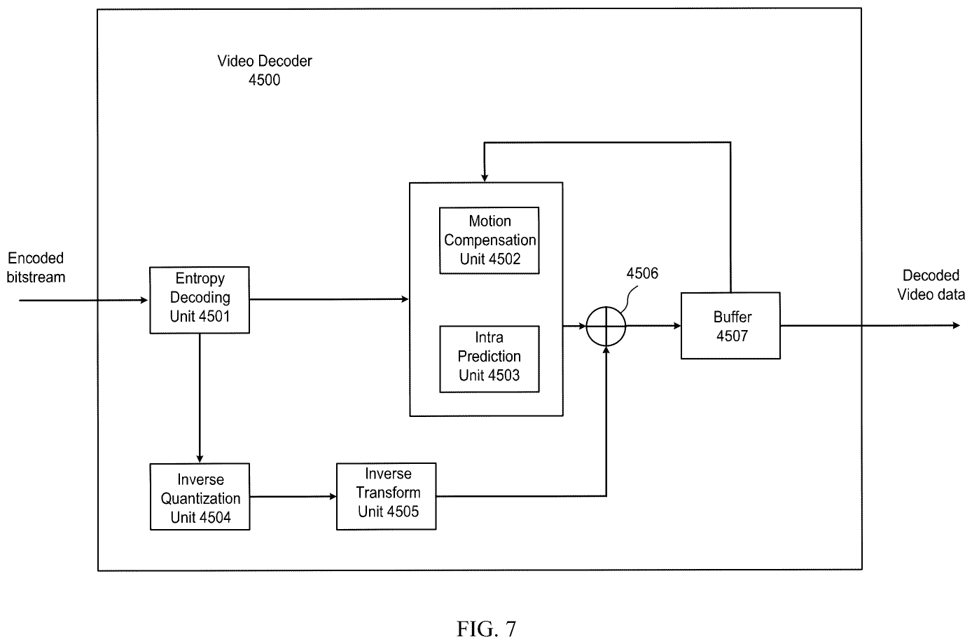

FIG. 7 is a block diagram illustrating an example of video decoder 4500 which may be video decoder 4324 in the system 4300 illustrated in FIG. 5. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

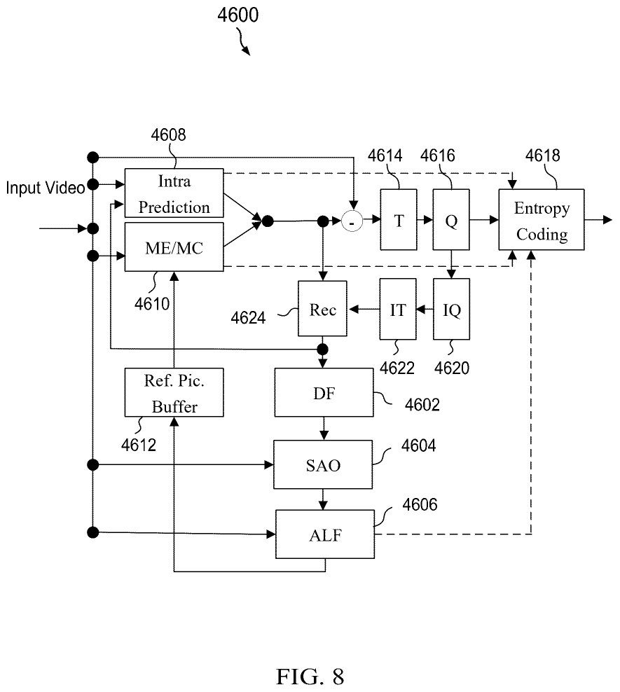

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

1. A method for processing media data comprising: determining to apply a Region-Adaptive Hierarchical Transform (RAHT) in Geometry based Point Cloud Compression (G-PCC) by disabling the alternating current (AC) inter-prediction based on the direct current (DC) of reference node (DC_{ref}), the DC of the current node (DC_{cur}), and one or more thresholds; and performing a conversion between a visual media data and a bitstream based on the RAHT.

2. The method of solution 1, wherein AC inter-prediction is disabled when the following condition is satisfied:

$$D {C}_{c u r} \leq T {h}_{1} * D {C}_{ref} or D {C}_{c u r} \geq T {h}_{2} * D {C}_{ref} .$$

3. The method of any of solutions 1-2, wherein DC_{ref} is in RAHT transform domain when inter-prediction is done in transform domain.

4. The method of any of solutions 1-3, wherein a condition is replaced based on the attributes value of the parent of the current node and the attributes of the parent of the reference node, or wherein DC_{cur} is replaced by the sum of attributes value of the parent of the current node and DC_{ref} is replaced by the sum of attributes value of the parent of the reference node, or wherein DC_{cur} is replaced by the average of attributes value of the parent of the current node and DC_{ref} is replaced by the average of attributes value of the parent of the reference node.

5. The method of any of solutions 1-4, wherein DC_{ref} or the sum/average of attributes of the parent of the reference are be derived from one or more nodes in a reference point cloud (PC) sample, or wherein DC_{ref} is derived from corresponding node in the reference PC sample, or wherein DC_{ref} is derived from corresponding node after motion compensation, or wherein DC_{ref} is derived by interpolating at a position in the reference PC sample.

6. The method of any of solutions 1-5, wherein the thresholds Th1 and Th2 are fixed at an encoder and a decoder, or wherein the thresholds Th1 and Th2 are sent to the decoder.

7. The method of any of solutions 1-6, wherein the thresholds are different for different scenarios, or wherein the threshold are different for different sequences or frames, or wherein the threshold are different for different attribute channels, or wherein the threshold are different for different regions or RAHT layers, or wherein the threshold depends on other factors including quantization parameters (QP) or global motion.

8. The method of any of solutions 1-7, wherein the condition employs less than or greater than.

9. The method of any of solutions 1-8, wherein interpolation techniques are used in the reference frame for AC inter-prediction when a reference node is not present at the motion compensated location.

10. The method of any of solutions 1-9, wherein the interpolation technique employs the nearest-neighbor interpolation, or wherein the nearest neighbor is based on Euclidean distance, or wherein the nearest neighbor is based on the closest Morton code.

11. The method of any of solutions 1-10, wherein interpolation depends on the DC of the current node, or wherein a search is performed in the reference PC sample to determine a node whose DC is closest to the current DC, or wherein both spatial distance, including Euclidean or Morton code difference, and the difference between DC of the current node and reference node are jointly used to determine the best reference node.

12. The method of any of solutions 1-11, wherein the interpolation at the reference node is based on multiple neighbors, or wherein the neighbors are weighted based on their distance to the point of interpolation, or wherein the number of such neighbors for interpolation are fixed, or wherein the number of such neighbors are different and depend on factors including RAHT layer or attribute channel, or wherein the maximum number or the minimum number of neighbors are sent to the decoder.

13. The method of any of solutions 1-12, wherein the interpolation is jointly applied with the eligibility criterion to disable the usage of the neighbors that are ineligible according to the proposed criterion.

14. The method of any of solutions 1-13, wherein the interpolation result is used to generate the inter prediction value.

15. The method of any of solutions 1-14, wherein after deriving the inter-prediction based on interpolation, the inter-prediction is further combined with the intra-prediction to obtain the final prediction, or wherein the final prediction is the average of both predictions, or wherein the final prediction is a weighted average and weights are pre-determined for different layers or explicitly sent to the decoder.

16. The method of any of solutions 1-15, wherein spatial neighbors in the current PC sample and the neighbors in the reference PC sample are jointly considered for a joint spatio-temporal prediction, or wherein the weights for interpolation depend on factors including temporal distance or spatial distance, or wherein the weights are fixed or explicitly sent to the decoder.

17. The method of any of solutions 1-16, wherein usage is signaled from encoder to decoder in a bitstream/frame/tile/slice/octree/etc.

18. The method of any of solutions 1-17, wherein usage is dependent on coded information including dimensions, color format, color component, or slice/picture type.

19. An apparatus for processing video data comprising: a processor; and a non-transitory memory with instructions thereon, wherein the instructions upon execution by the processor, cause the processor to perform the method of any of solutions 1-18.

20. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-18.

21. A non-transitory computer-readable recording medium storing a bitstream of a video which is generated by a method performed by a video processing apparatus, wherein the method comprises: determining to apply a Region-Adaptive Hierarchical Transform (RAHT) in Geometry based Point Cloud Compression (G-PCC) by disabling the alternating current (AC) inter-prediction based on the direct current (DC) of reference node (DC_{ref}), the DC of the current node (DC_{cur}), and one or more thresholds; and generating a bitstream based on the determining.

22. A method for storing bitstream of a video comprising: determining to apply a Region-Adaptive Hierarchical Transform (RAHT) in Geometry based Point Cloud Compression (G-PCC) by disabling the alternating current (AC) inter-prediction based on the direct current (DC) of reference node (DC_{ref}), the DC of the current node (DC_{cur}), and one or more thresholds; generating a bitstream based on the determining; and storing the bitstream in a non-transitory computer-readable recording medium.

23. A method, apparatus or system described in the present disclosure.

A listing of further example solutions is provided next.

1. A method for processing media data, comprising: determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized; and performing a conversion between a visual media data and a bitstream with the AC inter-prediction disabled.

2. The method of solution 1, further comprising disabling the AC inter-prediction when the following condition is satisfied:

$$D {C}_{c u r} \leq T {h}_{1} * D {C}_{ref} or D {C}_{c u r} \geq T {h}_{2} * D {C}_{ref}$$

where Th₁ is a first threshold from the one or more thresholds, and Th₂ is a second threshold from the one or more thresholds.

3. The method of any of solutions 1-2, wherein the DC_{ref} is in a RAHT transform domain when the AC inter-prediction is performed in a transform domain.

4. The method of solution 2, further comprising replacing the condition based on an attributes value of a parent of a current node and an attributes value of a parent of a reference node.

5. The method of solution 4, further comprising replacing the DC_{cur} with a sum of the attributes value of the parent of the current node, and replacing the DC_{ref} with a sum of the attributes value of the parent of the reference node.

6. The method of solution 4, further comprising replacing the DC_{cur} with an average of the attributes value of the parent of the current node, and replacing the DC_{ref} with an average of the attributes value of the parent of the reference node.

7. The method of any of solutions 1-6, wherein the DC_{ref} is derived from one or more nodes in a reference point cloud (PC) sample.

8. The method of any of solutions 1-6, wherein the sum of the attributes value of the parent of the reference node is derived from one or more nodes in a reference point cloud (PC) sample.

9. The method of any of solutions 1-6, wherein the average of the attributes value of the parent of the reference node is derived from one or more nodes in a reference point cloud (PC) sample.

10. The method of any of solutions 1-6, wherein the DC_{ref} is derived from a corresponding node in a reference point cloud (PC) sample.

11. The method of any of solutions 1-6, wherein the DC_{ref} is derived from a corresponding node after motion compensation.

12. The method of any of solutions 1-6, wherein the DC_{ref} is derived by interpolating at a position in a reference point cloud (PC) sample.

13. The method of solution 2, wherein the first threshold (Th₁) and the second threshold (Th₂) are fixed at an encoder and at a decoder.

14. The method of solution 2, wherein the first threshold (Th₁) and the second threshold (Th₂) are transmitted to a decoder.

15. The method of solution 1, wherein the one or more thresholds are different for at least one of different sequences and different frames.

16. The method of solution 1, wherein the one or more thresholds are different for different attribute channels.

17. The method of solution 1, wherein the one or more thresholds are different for at least one of different regions and different RAHT layers.

18. The method of solution 1, wherein the one or more thresholds are dependent on one or more factors comprising quantization parameter and global motion.

19. The method of solution 1, further comprising disabling the AC inter-prediction when the following condition is satisfied: DC_{cur}<Th₁*DC_{ref} or DC_{cur}>Th₂*DC_{ref} where Th₁ is a first threshold from the one or more thresholds, and Th₂ is a second threshold from the one or more thresholds.

20. The method of solution 1, further comprising using an interpolation technique in a reference frame for the AC inter-prediction when a reference node is not present at a motion compensation location.

21. The method of solution 20, wherein the interpolation technique comprises nearest-neighbor interpolation.

22. The method of solution 21, wherein the nearest-neighbor interpolation is based on a Euclidean distance.

23. The method of solution 21, wherein the nearest-neighbor interpolation is based on a closest Morton code.

24. The method of solution 20, wherein the interpolation technique depends on the DC_{cur}.

25. The method of solution 24, further comprising performing a search in a reference point cloud (PC) sample to determine a node with a DC closest to the DC_{cur}.

26. The method of solution 24, further comprising jointly determining a best reference node based on both a spatial distance and a difference between the DC_{cur} and DC_{ref}, wherein the spatial difference comprises a Euclidean distance or a Morton code distance.

27. The method of solution 20, wherein the interpolation technique comprises interpolation at a reference node, and wherein the interpolation at the reference node is based on a plurality of neighbors.

28. The method of solution 27, wherein each of the plurality of neighbors is weighted based on its distance to a point of interpolation.

29. The method of solution 27, wherein a number of the plurality of neighbors is fixed.

30. The method of solution 27, wherein a number of the plurality of neighbors is based on at least one of a RAHT layer and an attribute channel.

31. The method of solution 27, wherein one or more of a maximum number of the plurality of neighbors and a minimum number of the plurality of neighbors is transmitted to a decoder.

32. The method of solution 20, further comprising determining that one or more of the plurality of neighbors are ineligible for the interpolation technique based on an eligibility criterion, and disabling use of the one or more of the plurality of neighbors that were determined to be ineligible.

33. The method of solution 20, further comprising using an interpolation result to generate an inter-prediction value.

34. The method of solution 20, further comprising deriving the AC inter-prediction based on the interpolation technique, and then combining the AC inter-prediction with intra-prediction to obtain a final prediction.

35. The method of solution 34, wherein the final prediction comprises an average of the AC inter-prediction and the intra-prediction.

36. The method of solution 34, wherein the final prediction comprises a weighted average of the AC inter-prediction and the intra-prediction, and wherein weights are predetermined for different layers or transmitted to a decoder.

37. The method of solution 20, further comprising determining a spatio-temporal prediction based on spatial neighbors in a current point cloud (PC) sample and neighbors in a reference PC sample.

38. The method of solution 37, wherein weights for interpolation are based on factors including at least one of temporal distance and spatial distance.

39. The method of solution 37, wherein weights for interpolation are fixed or transmitted to a decoder.

40. The method of any of solutions 1-39, wherein whether to and/or how to apply any of the disclosed methods is signaled from an encoder to a decoder in at least one of a bitstream, a frame, a tile, a slice, or an octree.

41. The method of any of solutions 1-40, wherein whether to and/or how to apply any of the disclosed methods is based on coded information including one or more of a dimension, a color format, a color component, a slice type, and a picture type.

42. The method of any of solutions 1-41, wherein the conversion includes encoding the media data into a bitstream.

43. The method of any of solutions 1-41, wherein the conversion includes decoding the media data from a bitstream.

44. An apparatus for processing video data comprising: a processor; and a non-transitory memory with instructions thereon, wherein the instructions upon execution by the processor, cause the processor to perform the method of any of solutions 1-43.

45. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-43.

46. A non-transitory computer-readable recording medium storing a bitstream of a video which is generated by a method performed by a video processing apparatus, wherein the method comprises: determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized; and generating the bitstream with the AC inter-prediction disabled.

47. A method for storing bitstream of a video comprising: determining to disable alternating current (AC) inter-prediction based on a direct current (DC) of a reference node (DC_{ref}), a DC of a current node (DC_{cur}), and one or more thresholds when a Region-Adaptive Hierarchical Transform (RAHT) in Geometry-based Point Cloud Compression (G-PCC) is utilized; generating the bitstream with the AC inter-prediction disabled; and storing the bitstream in a non-transitory computer-readable recording medium.

48. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including+10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining to disable alternating current (AC) inter-prediction based on a direct current (DC) of a first reference node, a DC of a first current node, and one or more thresholds when a Region-Adaptive Hierarchical Transform (RAHT) in Geometry-based Point Cloud Compression (G-PCC) is utilized; and
performing a conversion between a visual media data and a bitstream based on the determining.

2. The method of claim 1, wherein the AC inter-prediction is disabled when a following condition is satisfied:
$$D {C}_{c u r} < T {h}_{1} * D {C}_{ref} or D {C}_{c u r} > T {h}_{2} * D {C}_{r e f}$$
where Th₁ is a first threshold from the one or more thresholds, Th₂ is a second threshold from the one or more thresholds, DC_{ref} indicates the DC of the first reference node, and DC_{cur} indicates the DC of the first current node.

3. The method of claim 1, wherein DC_{ref} indicating the DC of the first reference node is in a RAHT transform domain when the AC inter-prediction is performed in a transform domain.

4. The method of claim 2, further comprising replacing the condition based on attribute value(s) of a parent node of the first current node and attribute value(s) of a parent node of the first reference node;
wherein the DC_{cur} is replaced by a sum of the attribute value(s) of the parent node of the first current node, and the DC_{ref} is replaced by a sum of the attribute value(s) of the parent node of the first reference node; or the DC_{cur} is replaced by an average of the attribute value(s) of the parent node of the first current node, and the DC_{ref} is replaced by an average of the attribute value(s) of the parent node of the first reference node.

5. The method of claim 1, wherein DC_{ref} indicating the DC of the first reference node is derived from one or more nodes in a reference point cloud (PC) sample, or wherein the DC_{ref} is derived by interpolating at a position in a reference point cloud (PC) sample, and
wherein the DC_{ref} is a sum of attribute value(s) of a parent node of the first reference node, or the DC_{ref} is an average of attribute value(s) of a parent node of the first reference node.

6. The method of claim 1, wherein DC_{ref} indicating the DC of the first reference node is derived from a corresponding node in a reference point cloud (PC) sample.

7. The method of claim 1, wherein DC_{ref} indicating the DC of the first reference node is derived from a corresponding node after motion compensation.

8. The method of claim 2, wherein the first threshold (Th₁) and the second threshold (Th₂) are fixed at an encoder and at a decoder.

9. The method of claim 2, wherein the first threshold (Th₁) and the second threshold (Th₂) are signaled to a decoder.

10. The method of claim 1, wherein the one or more thresholds are different for different sequences,
wherein the one or more thresholds are different for different frames,
wherein the one or more thresholds are different for different attribute channels,
wherein the one or more thresholds are different for different regions,
wherein the one or more thresholds are different for different RAHT layers, or
wherein the one or more thresholds are dependent on one or more factors comprising quantization parameter and global motion.

11. The method of claim 1, further comprising using an interpolation technique in a reference frame for the AC inter-prediction when a second reference node is not present at a motion compensation location in the reference frame.

12. The method of claim 11, wherein the interpolation technique comprises nearest-neighbor interpolation;
wherein the nearest-neighbor interpolation is based on at least one of a Euclidean distance or a closest Morton code,
wherein the interpolation technique depends on a DC of a second current node,
wherein the method further comprises performing a search in a reference point cloud (PC) sample to determine a node with a DC closest to the DC of the second current node, and/or
wherein the method further comprises determining a best reference node based on both a spatial distance and a difference between the DC of the second current node and a DC of the second reference node, wherein the spatial distance comprises a Euclidean distance or a Morton code distance.

13. The method of claim 11, wherein the interpolation technique comprises interpolation at the second reference node, and wherein the interpolation at the second reference node is based on a plurality of neighbors,
wherein each of the plurality of neighbors is weighted based on its distance to a point of interpolation,
wherein a number of the plurality of neighbors is fixed,
wherein a number of the plurality of neighbors is based on at least one of a RAHT layer or an attribute channel,
wherein one or more of a maximum number of the plurality of neighbors and a minimum number of the plurality of neighbors is transmitted to a decoder,
wherein the method further comprises determining that one or more of the plurality of neighbors are ineligible for the interpolation technique based on an eligibility criterion, and disabling use of the one or more of the plurality of neighbors that are determined to be ineligible, and/or
wherein the method further comprises using an interpolation result to generate an inter-prediction value.

14. The method of claim 11, further comprising deriving an inter-prediction value of the AC inter-prediction based on the interpolation technique, and then combining the inter-prediction value with an intra-prediction value of intra-prediction to obtain a final prediction value,
wherein the final prediction value comprises an average of the inter-prediction value and the intra-prediction value or a weighted average of the inter-prediction value and the intra-prediction value, and wherein a weight of the inter-prediction value and a weight of the intra-prediction value are predetermined for different layers or transmitted to a decoder,
wherein the method further comprises determining a spatio-temporal prediction based on spatial neighbors in a current point cloud (PC) sample and neighbors in a reference PC sample,
wherein weights for interpolation are based on factors including at least one of temporal distance or spatial distance, and/or
wherein weights for interpolation are fixed or transmitted to a decoder.

15. The method of claim 1, wherein whether to and/or how to apply the method is signaled in at least one of a level of the bitstream, a level of a frame, a level of a tile, a level of a slice, or a level of an octree, or
wherein whether to and/or how to apply the method is based on coded information including one or more of a dimension, a color format, a color component, a slice type, and a picture type.

16. The method of claim 1, wherein the conversion includes encoding the visual media data into the bitstream.

17. The method of claim 1, wherein the conversion includes decoding the visual media data from the bitstream.

18. An apparatus for processing media data, comprising:
a processor; and
a non-transitory memory with instructions thereon, wherein the instructions upon execution by the processor, cause the processor to:
determine to disable alternating current (AC) inter-prediction based on a direct current (DC) of a first reference node, a DC of a first current node, and one or more thresholds when a Region-Adaptive Hierarchical Transform (RAHT) in Geometry-based Point Cloud Compression (G-PCC) is utilized; and
perform a conversion between a visual media data and a bitstream based on the determination.

19. A non-transitory computer readable storage medium storing instructions that cause a processor to:
determine to disable alternating current (AC) inter-prediction based on a direct current (DC) of a first reference node, a DC of a first current node, and one or more thresholds when a Region-Adaptive Hierarchical Transform (RAHT) in Geometry-based Point Cloud Compression (G-PCC) is utilized; and
perform a conversion between a visual media data and a bitstream based on the determination.

20. A non-transitory computer-readable recording medium storing a bitstream of media data which is generated by a method performed by a media data processing apparatus, wherein the method comprises:
determining to disable alternating current (AC) inter-prediction based on a direct current (DC) of a first reference node, a DC of a first current node, and one or more thresholds when a Region-Adaptive Hierarchical Transform (RAHT) in Geometry-based Point Cloud Compression (G-PCC) is utilized; and
generating the bitstream based on the determining.
